(19) United States
(12) Patent Application Publication
(10) Pub. No.: US 2024/0400121 A1
(43) Pub. Date: Dec. 5, 2024

(54) CART WITH DOUBLE-CENTER CHASSIS

(71) Applicant: Zhejiang Pride Leisure Products Co,. Ltd., Jinhua (CN)

(72) Inventor: Benlong SUN, Jinhua (CN)

(21) Appl. No.: 18/677,499

(22) Filed: May 29, 2024

(30) Foreign Application Priority Data
May 29, 2023 (CN) 202321328460.8

(51) Int. Cl. B62B 3/00; B62B 3/02; B62B 5/06

(52) U.S. Cl. CPC B62B 3/007; B62B 3/025; B62B 5/067; B62B 2205/06

(57) ABSTRACT

A cart with a double-center chassis having a chassis, and a frame arranged on the chassis and formed by a front wall, a back wall and two side walls. The chassis has two symmetrical sub-frames, two connecting seats and two pull connecting pieces. The side walls and the connecting seats are slidably connected through the pull connecting pieces. By having a double-center chassis, the problem of a large load at the center of the chassis is solved, the possibility of sinking of the chassis is lowered, and the load-bearing and supporting capacity of the chassis is improved.

### BACKGROUND OF THE INVENTION

### 1. Technical Field

The invention belongs to the technical field of carts, and particularly relates to a cart with a double-center chassis.

### 2. Description of Related Art

Carts, as transport vehicles pushed and pulled by manpower, can transport light articles at a short distance conveniently in places where motor vehicles cannot be used.

Some of existing carts are platform carts which cannot be folded and are inconvenient to carry and transport. The other existing carts are foldable carts. For example, Chinese Patent Publication No.CN219007856U discloses a capacity-expandable cart, which has an unfolded state and a folded state, and comprises multiple support vertical rods, multiple front and back cross tube assemblies, multiple side cross tube assemblies, a foldable bottom frame connected between all the support vertical rods, and multiple wheel assemblies arranged at bottoms of the corresponding support vertical rods, wherein the multiple support vertical rods are connected through two front and back cross tube assemblies and two side cross tube assemblies to form a frame, sliding tube assemblies are arranged on the support vertical rods, and the sliding tube assemblies ascend or descend with the telescoping of the front and back cross tube assemblies and/or the side cross tube assemblies. The foldable bottom frame on the bottom surface of the capacity-expandable cart are connected between all the support vertical rods, and is composed of four bottom tubes and a center seat, and one ends of the bottom tubes are connected with the four support vertical rods on front and back sides, so the center of the foldable bottom frame is likely to sink when articles placed in the cart are too heavy, and the articles on the cart will move towards the sinking area, which will further increase the load at the center of the foldable bottom frame and even cause damage to the foldable bottom frame.

### BRIEF SUMMARY OF THE INVENTION

In view of the defects in the prior art, the objective of the invention is to provide a cart with a double-center chassis, which solves the problem of a large load at the center of the chassis of traditional carts by means of a double-center chassis, lowers the possibility of sinking of the chassis, and improves the load-bearing and supporting capacity of the chassis.

To fulfil the above objective, the invention adopts the following technical solution: a cart with a double-center chassis comprises a chassis, and a frame arranged on the chassis and formed by a front wall, a back wall and two side walls, wherein the chassis comprises two symmetrical sub-frames, two connecting seats and two pull connecting pieces, each sub-frame comprises a center seat and four bottom tubes symmetrically riveted to the center seat, the two bottom tubes, close to the center, of each sub-frame are riveted to the two connecting seats respectively, and the other two tubes, away from the center, of each sub-frame are riveted to the front wall or the back wall; and upper ends of the pull connecting pieces are riveted to the side walls, and lower ends of the pull connecting pieces are slidably connected with the connecting seats.

Further, vertical through-holes are formed in the connecting seats, the lower ends of the pull connecting pieces penetrate through the through-holes and are able to slide upwards and downwards, and limiting parts for preventing the pull connecting pieces from designating from the through-holes are arranged at bottoms of the pull connecting pieces.

Further, vertical sliding grooves are formed in the pull connecting pieces, the lower ends of the pull connecting pieces are mounted on the connecting seats through pins, and rivets for riveting the upper ends of the pull connecting pieces to the side walls are able to slide vertically in the sliding grooves.

Further, each of the side walls comprises a folding unit, a front side and a back side of the folding unit are riveted to the front wall and the back wall respectively, and the upper ends of the pull connecting pieces are riveted to a lower portion of the center of the folding unit.

Furthermore, the folding unit comprises two symmetrical long tubes, two symmetrical short tubes and two symmetrical connecting tubes, wherein lower ends of the two long tubes are articulated, and upper ends of the two long tubes are riveted to an upper end of the front wall and an upper end of the back wall respectively; lower ends of the two short tubes are vertically and slidably connected with the front wall and the back wall respectively, upper ends of the two short tubes are articulated with upper ends of the connecting tubes, and the two short tubes are riveted to upper sections of the two long tubes; lower ends of the two connecting tubes are riveted to lower sections of the two long tubes; and the upper ends of the pull connecting pieces are riveted to the lower ends of the two long tubes.

Furthermore, the front wall comprises a group of vertical tubes, a group of sliding seats, a group of upper fixed seats, a group of lower fixed seats and a folding member, wherein one upper fixed seat and one lower fixed seats are arranged at an upper end and a lower end of each vertical tube respectively, the sliding seats are disposed around the vertical tubes and are able to slide vertically, two sides of an upper end of the folding member are riveted to the group of upper fixed seats receptively, and two sides of a lower end of the folding member are riveted to the group of sliding seats respectively; the back wall is identical in structure with the front wall;

In each folding unit, the upper ends of the two long tubes are riveted to one upper fixed seat of the front wall and one upper fixed seat of the back wall respectively, the lower ends of the two short tubes are slidably riveted with the front wall and the back wall respectively, and slidable connection is realized through the sliding seats;

The two bottom tubes, away from the center, of each sub-frame are riveted to the group of lower fixed seats of the front wall or the back wall respectively.

Furthermore, the folding member comprises two articulated X-shaped tubes, and each said X-shaped tube is formed by cross riveting of two cross tubes.

Furthermore, an articulation piece is used for realizing articulation, the articulation piece comprises a left riveting piece and a right riveting piece which are symmetrical in structure, one end of the left riveting piece and one end of the right riveting piece are rotatably connected, and the other end of the left riveting piece or the other end of the right riveting piece is inserted into one long tube, one short tube, one connecting tube or one cross tube to be fixed.

Further, the cart with a double-center chassis further comprises a hand lever assembly arranged on the back wall, wherein the hand lever assembly comprises a handle, an upper pull tube, a hand lever base and two symmetrical lower pull tubes, the handle is arranged at an upper end of the upper pull tube, the upper pull tube is slidably connected with the hand lever base, and an upper end and a lower end of each said lower pull tube are riveted to the hand lever base and the corresponding lower fixed seat respectively.

Further, caster brackets are arranged at upper ends of casters, axles are fixed at upper ends of the caster brackets, and upper ends of the axles are inserted into the vertical tubes.

Furthermore, the casters on the back wall are casters provided with brakes.

By adopting the above technical solution, the invention has the following beneficial effects: the chassis formed by two sub-frames, two connecting seats and two pull connecting pieces is connected with the front wall, the back wall and the side walls, and when the cart is unfolded to be used, the chassis can be supported by the front wall and the back wall and can be pulled by the two side walls, such that the support effect of the chassis effectively improved, and the support firmness of the cart is improved; and the whole cart is foldable, thus being easy to store and transport, and convenient and fast to unfold and use.

### BRIEF DESCRIPTION OF THE SEVERAL VIEWS OF THE DRAWINGS

FIG. 1 is a three-dimensional view of a cart with a double-center chassis according to Embodiment 1;

FIG. 2 is a schematic diagram of the cart with a double-center chassis in the side wall direction according to Embodiment 1;

FIG. 3 is a schematic diagram of the cart with a double-center chassis in the front wall direction according to Embodiment 1;

FIG. 4 is an exploded view of the cart with a double-center chassis according to Embodiment 1;

FIG. 5 is a three-dimensional view of a hand lever assembly;

FIG. 6 is an exploded view of an upper fixed seat and a vertical tube;

FIG. 7 is a three-dimensional view of a cart with a double-center chassis according to Embodiment 2;

FIG. 8 is an exploded view of an upper connecting piece of the cart with a double-center chassis according to Embodiment 2.

In the figures: 1, front wall; 11, vertical tube; 11a, vertical tube through-hole; 12, upper fixed seat; 12a, limiting hole; 13, lower fixed seat; 14, sliding seat; 15, X-shaped tube; 16, end cover; 16a, end cover through-hole; 17, U-shaped elastic piece; 18, positioning pin; 2, back wall; 3, side wall; 31, long tube; 32, short tube; 33, connecting tube; 4, chassis; 41, center seat; 42, bottom tube; 43, connecting seat; 431 through-hole; 44, pull connecting piece; 44a, limiting part; 5, caster; 51, axle; 52, caster bracket; 6, hand lever assembly; 61, handle; 62, upper pull tube; 63, hand lever base; 63a, hole; 64, lower pull tube; 65, pull tube connecting piece; 7, articulation piece; 71, left riveting piece; 72, right riveting piece; 8, upper pull sheet; 9, pin.

### DETAILED DESCRIPTION OF THE INVENTION

Specific embodiments of the specific solution of the invention will be further expounded below in conjunction with the accompanying drawings to gain a better understanding of the technical solution of the invention.

### Embodiment 1

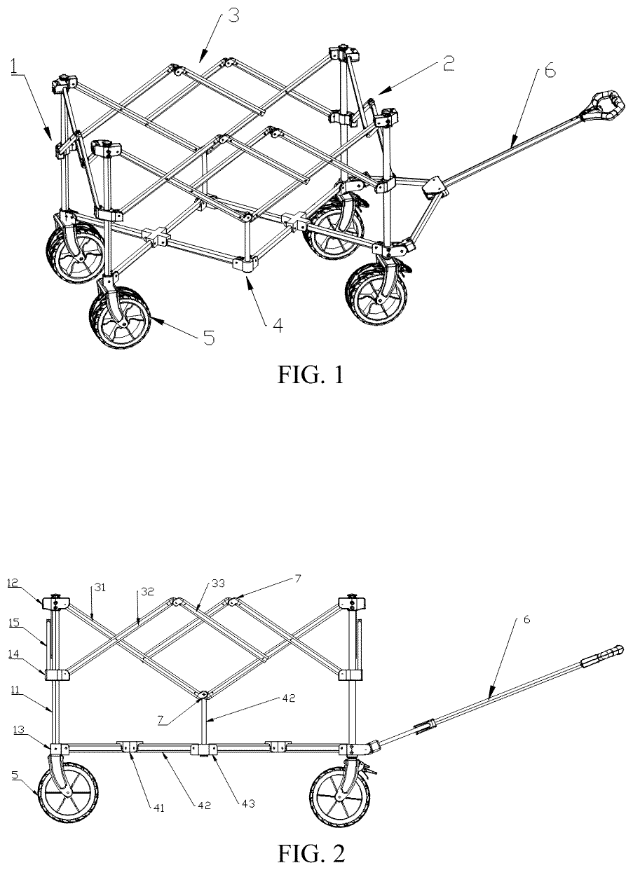

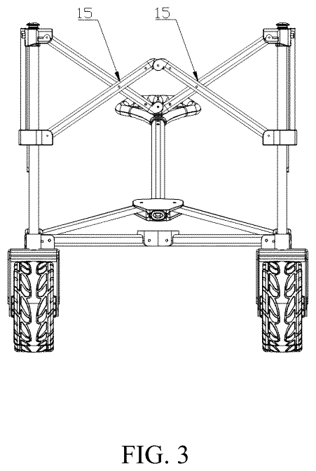

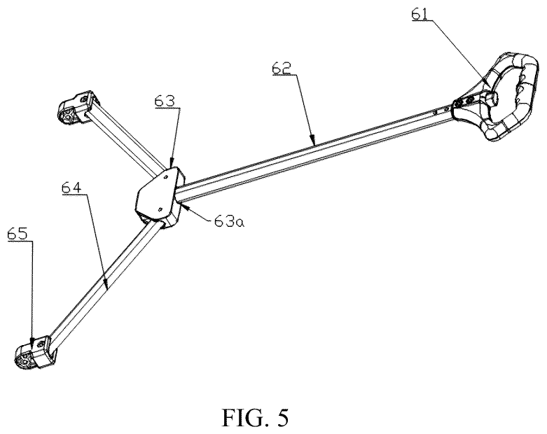

As shown in FIG. 1-FIG. 6, this embodiment relates to a cart with a double-center chassis, which comprises a chassis 4, and a frame arranged on the chassis 4 and formed by a front wall 1, a back wall 2 and two side walls 3, wherein the chassis 4 comprises two symmetrical sub-frames, two connecting seats 43 and two pull connecting pieces 44, each sub-frame comprises a center seat 41 and four bottom tubes 42 symmetrically riveted to four corners of the center seat 41, the two bottom tubes 42, close to the center, of each sub-frame are riveted to the two connecting seats 43 respectively, and the other two bottom tubes 42 of each sub-frame are riveted to the front wall 1 or the back wall 2; and upper ends of the pull connecting pieces 44 are riveted to the side walls 3, and lower ends of the pull connecting pieces 44 are vertically and slidably connected with the connecting seats 43. In this embodiment, the pull connecting pieces 44 are circular tubes.

Specifically, vertical through-holes 43a are formed in the connecting seats 43, the lower ends of the pull connecting pieces 44 penetrate through the through-holes 43a and are able to slide upwards and downwards along the through holes, and limiting parts 44a for preventing the pull connecting pieces 44 from designating from the through-holes 43a are arranged at bottoms of the pull connecting pieces 44.

Each of the side walls 3 comprises a folding unit, wherein a front side and a back side of the folding unit are riveted to the front wall 1 and the back wall 2 respectively, and the upper end of each pull connecting piece 44 is riveted to a lower portion of the center of one folding unit. The folding unit comprises two symmetrical long tubes 31, two symmetrical short tubes 32, and two symmetrical connecting tubes 33, wherein lower ends of the two long tubes 31 are articulated, and upper ends of the two long tubes 31 are riveted to an upper fixed seat 12 on the front wall 1 and an upper fixed seat 12 on the back wall 2 respectively; lower ends of the two short tubes 32 are riveted to sliding seats 14, upper ends of the two short tubes 32 are articulated with upper ends of the connecting tubes 33, and the two short tubes 32 are riveted to upper sections of the two long tubes 31; and lower ends of the two connecting tubes 33 are riveted to lower sections of the two long tubes 31, and upper ends of the pull connecting pieces 44 are riveted to lower ends of the two long tubes 31. Every two riveted tubes can rotate relatively, such that the side walls 3 can be folded towards the center, and the horizontal area of the side walls 3 is reduced.

Because the lower ends of the two long tubes 31 are articulated through an articulation piece 7, the upper end of each pull connecting piece 44 is riveted to the articulation piece 7 connecting the corresponding two long tubes 31.

In this embodiment, the front wall 1 comprises a group of vertical tubes 11, a group of sliding seats 14, a group of upper fixed seats 12, a group of lower fixed seats 13, and a folding member, wherein one upper fixed seat 12 and one lower fixed seat 13 are arranged at an upper end and a lower end of each vertical tube 11, the sliding seats 14 are disposed around the vertical tubes 11 and are able to slide upwards and downwards, left and right sides of an upper end of the folding member are riveted to the group of upper fixed seats 12 respectively, and two sides of a lower end of the folding member are riveted to the group of sliding seats 14 respectively. The back wall 2 is identical in structure with the front wall 1.

In the folding unit of each side wall 3, the upper ends of the two long tubes 31 are riveted to the one fixed seat 12 of the front wall 1 and one upper fixed seat 12 of the back wall 2 respectively, the lower ends of the two short tubes 32 are riveted to one sliding seat 14 of the front wall 1 and one sliding seat 14 of the back wall 2 respectively, and vertical and slidable connection is realized through the sliding seats 14.

The two bottom tubes 42, away from the center, of each sub-frame of the chassis 4 are riveted to the group of lower fixed seats 13 of the front wall 1 or the back wall 2 respectively.

In the front wall 1 or the back wall 2, the folding member comprises two articulated X-shaped tubes 15, and each X-shaped tube 15 is formed by cross riveting of two cross tubes. The two riveted cross tubes can be folded, the two articulated X-shaped tubes 151 can be folded towards the center, and the horizontal area of the front wall or the back wall can be reduced through the folding member.

In this embodiment, articulation pieces 7 are used for realizing articulation. The articulation piece 72 comprises a left riveting piece 71 and a right riveting piece 72 which are symmetrical in structure, wherein one end (circular end) of the left riveting piece 71 and one end (circular end) of the right riveting piece 72 are rotatably connected through a rivet, the other end (square end) of the left riving piece 71 or the other end (square end) of the right riveting piece 72 is riveted to one end of one long tube 31, one short tube 32, one connecting tube 33, or one cross tube of one X-shaped tube 151 and is fixed with a fastener (such as a screw). In this way, rotatable connection of the side walls 3, or front wall 1 or back wall 2 can be realized through the articulation piece 7 formed by the left riveting piece 71 and the right riveting piece 72, and each side of the frame of the cart can be folded or unfolded.

Caster brackets 52 are arranged upper ends of casters 5, axles 51 are fixed at upper ends of the caster brackets 52, and upper ends of the axles 51 are inserted into the vertical tubes 11. The casters 5 on the back wall 2 are provided with brakes, and the casters provided with brakes can be purchased from the market, or the tire brake systems in Patent Publication No. CN217575319U are used as the casters provided with brakes.

To allow users to pull the cart easily, a hand lever assembly 6 is arranged on the back wall 2. The hand lever assembly 6 comprises an handle 61, an upper pull tube 62, a hand lever base 63, two symmetrical lower pull tubes 64, and two pull tube connecting pieces 65, wherein one end of each of the two lower pull tubes 64 is riveted to a lower side of the hand lever base 63 and is able to rotate towards the center, the other end of each of the two lower pull tubes 64 is riveted to one pull tube connecting piece 65, and each pull tube connecting piece 65 is riveted to a front side of one lower fixed seat 14; the handle 61 is arranged at an upper end of the upper pull tube 62, and a lower end of the upper pull tube 62 penetrates through a vertical hole 63a of the hand lever base 63 and is movably connected with the hand lever base 63, that is, the upper pull tube 62 is able to slide upwards and downwards in the through-hole. Through the pull tube connecting pieces 65, the upper pull tube 62, the hand lever base 63 and the lower pull tubes 64 can be driven to rotate towards the corresponding lower fixed seats 14 to draw close to the back wall 2, and the upper pull tube 62 slides downwards to drive the handle 61 to draw close to the hand lever base 63, such that the whole hand lever assembly is folded.

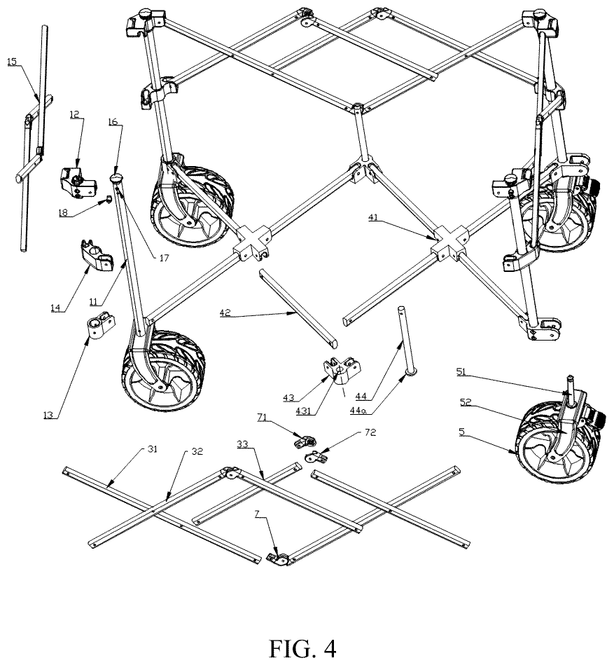

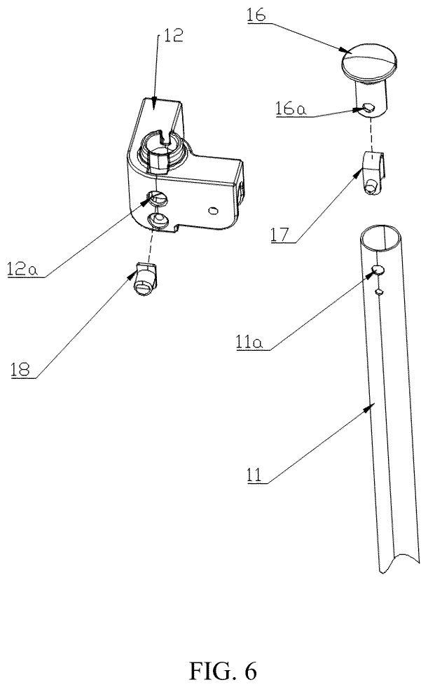

Because the sliding seats 14 are mounted on the vertical tubes 11, limiting assemblies are arranged at tops of the vertical tubes 11 to improve the assembly firmness of the upper fixed seats 12. As shown in FIG. 4 and FIG. 6, each of the limiting assemblies comprises an end cover 16, a U-shaped elastic piece 17 and a positioning pin 18, wherein a lower end of the end cover 16 is downward inserted into the corresponding vertical tube 11, a hinge pin on one side of the U-shaped elastic piece 17 in the end cover 16 penetrates through an end cover through-hole 16a and the corresponding vertical tube through-hole 11a to abut against a rear end of the positioning pin 18, the positioning pin 18 is mounted on the corresponding upper fixed seat 12, a front end of the positioning pin 18 protrudes to stretch out of a limiting hole 12b of the corresponding upper fixed seat 12, a rear end of the positioning pin 18 has an arc surface matched with a tube wall of the corresponding vertical tube 11, and a cap of the end cover 16 covers an opening of the corresponding vertical tube 11. The upper fixed seats 12 are fixed on the vertical tubes 11 through fasteners such as screws, and the screws are mounted below the limiting holes 12a.

In this embodiment, a cloth bag located on the chassis may be arranged in the frame to store small articles. Preferably, the cloth bag is rectangular, a top surface of the cloth bag is open, and four sides of the cloth bag are detachably connected to the front wall 1, the back wall 2 and the two side walls 3 respectively.

### Embodiment 2

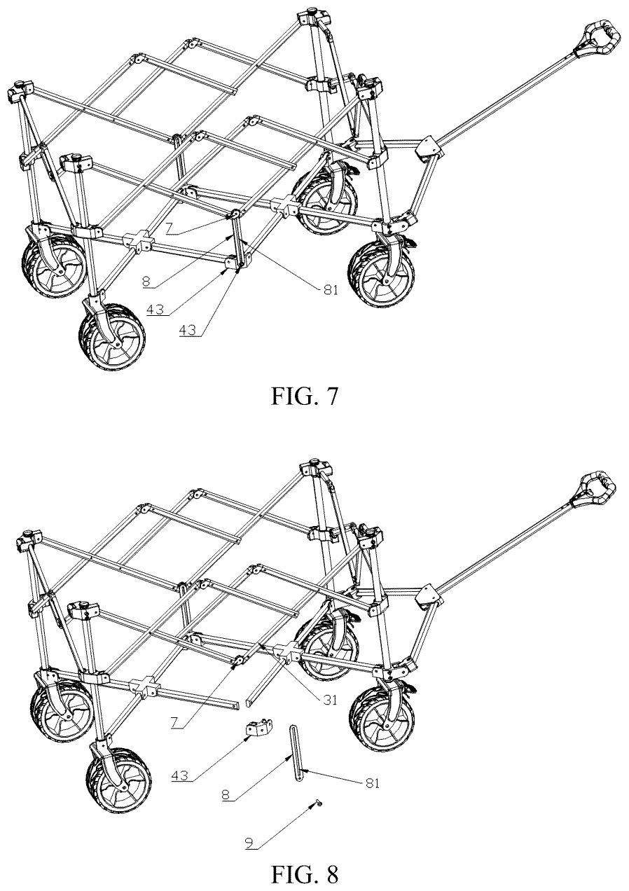

As shown in FIG. 7-FIG. 8, different from Embodiment 1, in this embodiment, the pull connecting pieces of the chassis 4 are pull sheets 8, vertical sliding grooves 81 are formed in the pull sheets 8, lower ends of the pull sheets 8 are mounted on side faces of the connecting seats 43 through pins 9, and rivets for riveting the upper ends of the pull sheets 8 to the side walls 3 are able to slide vertically in the sliding grooves 81. Specifically, in the articulation piece 7 for articulating the lower ends of the two long tubes 31, a rivet for rotatably connecting one end (circular end) of the left riveting piece and one end (circular end) of the right riveting piece penetrates through the corresponding sliding groove 81 and is able to slide upwards and downwards along the corresponding sliding groove 81. When the side walls 3 are folded to fold the cart, the lower ends of the two long tubes 31 move downward, and the rivets are driven to slide downwards in the sliding grooves 81.

Preferably, based on Embodiment 1, two horizontal tubes are additionally arranged on the back wall in this embodiment, one end of each horizontal tube is riveted to one upper fixed seat, and the other end of each horizontal tube is articulated with an upper end of one cross tube. The structure of the front wall is identical with the structure of the front wall in Embodiment 1, or is identical with the structure of the back wall in this embodiment.

It should be noted that the above embodiments are merely preferred ones of the invention and are used to explain the technical principle of the invention. Those skilled in the art should understand that the invention is not limited to these specific embodiments described here, and those skilled in the art can make various changes, readjustments and substitutions without departing from the protection scope of the invention. Thus, although the invention has been described in detail with reference to the above embodiments, the invention is not limited to the above embodiments, and may include more other equivalent embodiments without departing from the concept of the invention. The scope of the invention is defined by the appended claims.

What is claimed is:

1. A cart with a double-center chassis, comprising:
a chassis;
a frame arranged on the chassis and formed by a front wall, a back wall and two side walls;
wherein the chassis comprises two symmetrical sub-frames, two connecting seats and two pull connecting pieces;
each said sub-frame comprises a center seat and four bottom tubes symmetrically riveted to the center seat;
the two bottom tubes, close to a center, of each said sub-frame are riveted to the two connecting seats respectively; and
the other two tubes, away from the center, of each said sub-frame are riveted to the front wall or the back wall;
wherein the side walls and the connecting seats are slidably connected through the pull connecting pieces.

2. The cart with a double-center chassis according to claim 1, wherein vertical through-holes are formed in the connecting seats, lower ends of the pull connecting pieces penetrate through the through-holes and are able to slide upwards and downwards, and limiting parts for preventing the pull connecting pieces from designating from the through-holes are arranged at bottoms of the pull connecting pieces.

3. The cart with a double-center chassis according to claim 1, wherein vertical sliding grooves are formed in the pull connecting pieces, lower ends of the pull connecting pieces are mounted on the connecting seats through pins, and rivets for riveting the upper ends of the pull connecting pieces to the side walls are able to slide vertically in the sliding grooves.

4. The cart with a double-center chassis according to any one of claim 1, wherein each of the side walls comprises a folding unit, a front side and a back side of the folding unit are riveted to the front wall and the back wall respectively, and the upper ends of the pull connecting pieces are riveted to the folding unit.

5. The cart with a double-center chassis according to claim 4, wherein the folding unit comprises two symmetrical long tubes, two symmetrical short tubes and two symmetrical connecting tubes, lower ends of the two long tubes are articulated, and upper ends of the two long tubes are riveted to an upper end of the front wall and an upper end of the back wall respectively; lower ends of the two short tubes are vertically and slidably connected with the front wall and the back wall respectively, upper ends of the two short tubes are articulated with upper ends of the connecting tubes, and the two short tubes are riveted to upper sections of the two long tubes; lower ends of the two connecting tubes are riveted to lower sections of the two long tubes; and upper ends of the pull connecting pieces are riveted to the lower ends of the two long tubes.

6. The cart with a double-center chassis according to claim 5, wherein the front wall comprises a group of vertical tubes, a group of sliding seats, a group of upper fixed seats, a group of lower fixed seats and a folding member, one said upper fixed seat and one said lower fixed seats are arranged at an upper end and a lower end of each said vertical tube respectively, the sliding seats are disposed around the vertical tubes and are able to slide vertically, two sides of an upper end of the folding member are riveted to the group of upper fixed seats receptively, and two sides of a lower end of the folding member are riveted to the group of sliding seats respectively; the back wall is identical in structure with the front wall;
in each said folding unit, the upper ends of the two long tubes are riveted to one said upper fixed seat of the front wall and one said upper fixed seat of the back wall respectively, the lower ends of the two short tubes are slidably riveted with the front wall and the back wall respectively, and slidable connection is realized through the sliding seats;
the two bottom tubes, away from the center, of each said sub-frame are riveted to the group of lower fixed seats of the front wall or the back wall respectively.

7. The cart with a double-center chassis according to claim 6, wherein the folding member comprises two articulated X-shaped tubes, and each said X-shaped tube is formed by cross riveting of two cross tubes.

8. The cart with a double-center chassis according to claim 7, wherein an articulation piece is used for realizing articulation, the articulation piece comprises a left riveting piece and a right riveting piece which are symmetrical in structure, one end of the left riveting piece and one end of the right riveting piece are rotatably connected, and the other end of the left riveting piece or the other end of the right riveting piece is inserted into one said long tube, one said short tube, one said connecting tube or one said cross tube to be fixed.

9. The cart with a double-center chassis according to claim 1, wherein the cart further comprises a hand lever assembly arranged on the back wall, the hand lever assembly comprises a handle, an upper pull tube, a hand lever base and two symmetrical lower pull tubes, the handle is arranged at an upper end of the upper pull tube, the upper pull tube is slidably connected with the hand lever base, and an upper end and a lower end of each said lower pull tube are riveted to the hand lever base and the corresponding lower fixed seat respectively.

10. The cart with a double-center chassis according to claim 1, wherein caster brackets are arranged at upper ends of casters, axles are fixed at upper ends of the caster brackets, and upper ends of the axles are inserted into the vertical tubes;
or, the casters on the back wall are casters provided with brakes.

11. The cart with a double-center chassis according to any one of claim 2, wherein each of the side walls comprises a folding unit, a front side and a back side of the folding unit are riveted to the front wall and the back wall respectively, and the upper ends of the pull connecting pieces are riveted to the folding unit.

12. The cart with a double-center chassis according to claim 11, wherein the folding unit comprises two symmetrical long tubes, two symmetrical short tubes and two symmetrical connecting tubes, lower ends of the two long tubes are articulated, and upper ends of the two long tubes are riveted to an upper end of the front wall and an upper end of the back wall respectively; lower ends of the two short tubes are vertically and slidably connected with the front wall and the back wall respectively, upper ends of the two short tubes are articulated with upper ends of the connecting tubes, and the two short tubes are riveted to upper sections of the two long tubes; lower ends of the two connecting tubes are riveted to lower sections of the two long tubes; and upper ends of the pull connecting pieces are riveted to the lower ends of the two long tubes.

13. The cart with a double-center chassis according to claim 12, wherein the front wall comprises a group of vertical tubes, a group of sliding seats, a group of upper fixed seats, a group of lower fixed seats and a folding member, one said upper fixed seat and one said lower fixed seats are arranged at an upper end and a lower end of each said vertical tube respectively, the sliding seats are disposed around the vertical tubes and are able to slide vertically, two sides of an upper end of the folding member are riveted to the group of upper fixed seats receptively, and two sides of a lower end of the folding member are riveted to the group of sliding seats respectively; the back wall is identical in structure with the front wall;
in each said folding unit, the upper ends of the two long tubes are riveted to one said upper fixed seat of the front wall and one said upper fixed seat of the back wall respectively, the lower ends of the two short tubes are slidably riveted with the front wall and the back wall respectively, and slidable connection is realized through the sliding seats;
the two bottom tubes, away from the center, of each said sub-frame are riveted to the group of lower fixed seats of the front wall or the back wall respectively.

14. The cart with a double-center chassis according to claim 13, wherein the folding member comprises two articulated X-shaped tubes, and each said X-shaped tube is formed by cross riveting of two cross tubes.

15. The cart with a double-center chassis according to claim 14, wherein an articulation piece is used for realizing articulation, the articulation piece comprises a left riveting piece and a right riveting piece which are symmetrical in structure, one end of the left riveting piece and one end of the right riveting piece are rotatably connected, and the other end of the left riveting piece or the other end of the right riveting piece is inserted into one said long tube, one said short tube, one said connecting tube or one said cross tube to be fixed.

16. The cart with a double-center chassis according to any one of claim 3, wherein each of the side walls comprises a folding unit, a front side and a back side of the folding unit are riveted to the front wall and the back wall respectively, and the upper ends of the pull connecting pieces are riveted to the folding unit.

17. The cart with a double-center chassis according to claim 16, wherein the folding unit comprises two symmetrical long tubes, two symmetrical short tubes and two symmetrical connecting tubes, lower ends of the two long tubes are articulated, and upper ends of the two long tubes are riveted to an upper end of the front wall and an upper end of the back wall respectively; lower ends of the two short tubes are vertically and slidably connected with the front wall and the back wall respectively, upper ends of the two short tubes are articulated with upper ends of the connecting tubes, and the two short tubes are riveted to upper sections of the two long tubes; lower ends of the two connecting tubes are riveted to lower sections of the two long tubes; and upper ends of the pull connecting pieces are riveted to the lower ends of the two long tubes.

18. The cart with a double-center chassis according to claim 17, wherein the front wall comprises a group of vertical tubes, a group of sliding seats, a group of upper fixed seats, a group of lower fixed seats and a folding member, one said upper fixed seat and one said lower fixed seats are arranged at an upper end and a lower end of each said vertical tube respectively, the sliding seats are disposed around the vertical tubes and are able to slide vertically, two sides of an upper end of the folding member are riveted to the group of upper fixed seats receptively, and two sides of a lower end of the folding member are riveted to the group of sliding seats respectively; the back wall is identical in structure with the front wall;
in each said folding unit, the upper ends of the two long tubes are riveted to one said upper fixed seat of the front wall and one said upper fixed seat of the back wall respectively, the lower ends of the two short tubes are slidably riveted with the front wall and the back wall respectively, and slidable connection is realized through the sliding seats;
the two bottom tubes, away from the center, of each said sub-frame are riveted to the group of lower fixed seats of the front wall or the back wall respectively.

19. The cart with a double-center chassis according to claim 18, wherein the folding member comprises two articulated X-shaped tubes, and each said X-shaped tube is formed by cross riveting of two cross tubes.

20. The cart with a double-center chassis according to claim 19, wherein an articulation piece is used for realizing articulation, the articulation piece comprises a left riveting piece and a right riveting piece which are symmetrical in structure, one end of the left riveting piece and one end of the right riveting piece are rotatably connected, and the other end of the left riveting piece or the other end of the right riveting piece is inserted into one said long tube, one said short tube, one said connecting tube or one said cross tube to be fixed.
